(19) United States
(12) Patent Application Publication
(10) Pub. No.: US 2020/0072131 A1
(43) Pub. Date: Mar. 5, 2020

(54) INTERNAL COMBUSTION ENGINE

(71) Applicant: AISIN SEIKI KABUSHIKI KAISHA, Kariya-shi (JP)

(72) Inventors: Suguru KAMIYA, Takahama-shi (JP); Seiichi FUJIMOTO, Chiryu-shi (JP); Masaaki KANEKO, Nukata-gun (JP); Atsushi HANAURA, Handa-shi (JP)

(73) Assignee: AISIN SEIKI KABUSHIKI KAISHA, Kariya-shi (JP)

(21) Appl. No.: 16/553,793

(22) Filed: Aug. 28, 2019

(30) Foreign Application Priority Data
Aug. 29, 2018 (JP) 2018-160583

(51) Int. Cl. F02D 9/02; F02D 41/00; F02B 31/04

(52) U.S. Cl. CPC F02D 9/02; F02D 41/0002; F02B 2031/003; F02D 2041/001; F02B 31/04

(57) ABSTRACT

An internal combustion engine includes: an intake control valve provided on an upstream side of a fuel injection device provided in an intake flow path and configured to adjust an opening degree thereof while maintaining an intake state through the intake flow path; and a controller configured to perform control to adjust the opening degree of the intake control valve, in which the controller is configured to set the intake control valve to a closing direction side such that a pressure between the intake control valve and an intake valve of a combustion chamber increases during a pre-ignition motor drive period until a fuel is supplied to the combustion chamber and first ignited.

### CROSS REFERENCE TO RELATED APPLICATIONS

This application is based on and claims priority under 35 U.S.C. § 119 to Japanese Patent Application 2018-160583, filed on Aug. 29, 2018, the entire contents of which are incorporated herein by reference.

### TECHNICAL FIELD

This disclosure relates to an internal combustion engine, and more particularly to an internal combustion engine having an intake control valve.

### BACKGROUND DISCUSSION

Conventionally, an internal combustion engine having an intake control valve is known (see, e.g., JP2008-274827A (Reference 1)).

Reference 1 discloses an engine including an intake control valve (TCV), a fuel injection valve, a starter motor which drives a crankshaft in order to start the engine, and an ECU. The ECU performs control to promote atomization of a fuel injected from the fuel injection valve by generating an eddy current by the TCV when the engine is started by the starter motor. At this time, the ECU performs control to relatively increase the initial injection amount of the fuel and to reduce the injection amount of the fuel when the eddy current could be generated (after the initial stage).

However, in the engine described in Reference 1, since the fuel may adhere to and remain on an intake flow path according to the injection amount of the fuel immediately after starting (initial stage), the amount of exhaust gas generated immediately after first ignition (at the time of starting) may not be sufficiently reduced.

Thus, a need exists for an internal combustion engine which is not susceptible to the drawback mentioned above.

### SUMMARY

An internal combustion engine according to an aspect of this disclosure includes an intake control valve provided on an upstream side of a fuel injection device provided in an intake flow path and configured to adjust an opening degree thereof while maintaining an intake state through the intake flow path and a controller configured to perform control to adjust the opening degree of the intake control valve, in which the controller is configured to set the intake control valve to a closing direction side such that a pressure between the intake control valve and an intake valve of a combustion chamber increases during a pre-ignition motor drive period until a fuel is supplied to the combustion chamber and first ignited.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view schematically illustrating a configuration of a vehicle having an engine according to an embodiment disclosed here;

FIG. 2 is a view schematically illustrating a configuration of the engine according to the embodiment disclosed here;

FIG. 3 is a view illustrating a valve timing at the time of motoring (a pre-ignition motor drive period) according to the embodiment disclosed here;

FIG. 4 is a view illustrating a valve timing at the time of ignition according to the embodiment disclosed here;

FIG. 5 is a view for comparing an IVC phase, a TCV opening degree, and an engine rotation speed at the time of motoring and at the time of ignition;

FIG. 6 is a flowchart of an engine starting control processing by a controller until first ignition is performed;

FIG. 7 is a view illustrating a relationship between the TCV opening degree and the gas temperature in an intake flow path during one cycle of motoring at the engine rotation speed of 1500 rpm;

FIG. 8 is a view illustrating a relationship between the TCV opening degree and the gas temperature in the intake flow path during motoring at the engine rotation speed of 2500 rpm;

FIG. 9 is a view illustrating a relationship between the TCV opening degree and the in-cylinder pressure during motoring at the engine rotation speed of 2500 rpm;

FIG. 10 is a view schematically illustrating a configuration of an engine according to a first modification of the embodiment disclosed here; and

FIG. 11 is a view illustrating a valve timing at the time of motoring (a pre-ignition motor drive period) according to a second modification of the embodiment disclosed here.

### DETAILED DESCRIPTION

Hereinafter, a specific embodiment disclosed here will be described based on the drawings.

### Embodiment

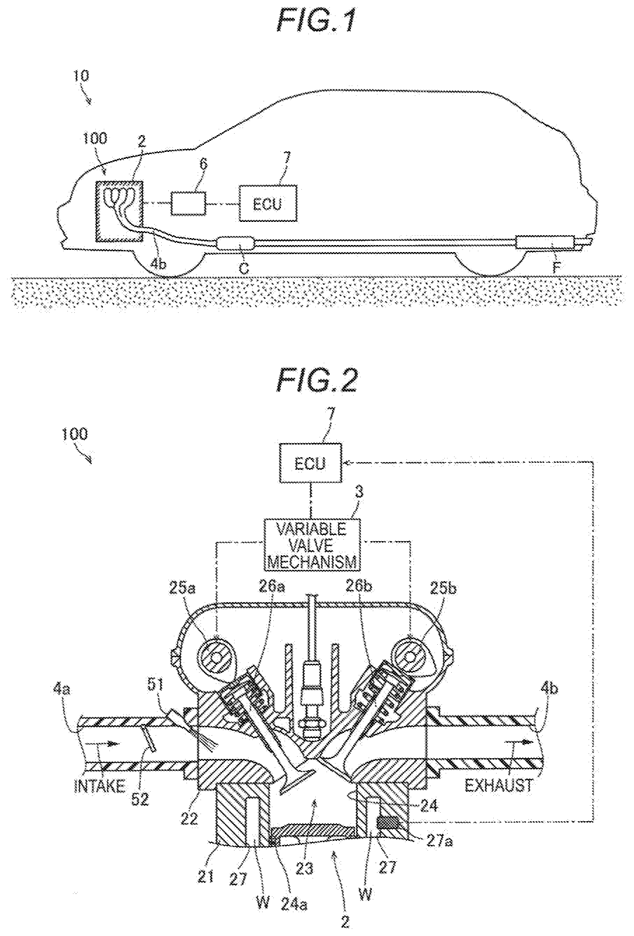

A configuration of an engine 100 (an example of an internal combustion engine) according to an embodiment will be described with reference to FIGS. 1 to 9.

As illustrated in FIG. 1, the engine 100 of the present embodiment is assembled in a hybrid vehicle 10.

As illustrated in FIG. 2, the engine 100 includes an engine body 2 (an example of an internal combustion engine body), a variable valve mechanism (VVT) 3, an intake flow path 4a connected to a combustion chamber 23 from the upstream side, an exhaust flow path 4b connected to the combustion chamber 23 from the downstream side, a fuel injection device 51, a tumble control valve (TCV) 52 (an example of an intake control valve), an electric motor 6 (an example of a hybrid drive motor) used for motoring, and an engine control unit (ECU) 7 (an example of a controller).

Here, in the present embodiment, the ECU 7 is configured to set the TCV 52 to a more closing direction side than when ignition (firing) is performed such that the pressure between the TCV 52 and an intake valve 26a of the combustion chamber 23 increases during a pre-ignition motor drive period (at the time of motoring before first ignition) until a fuel is supplied to the combustion chamber 23 and is first ignited.

Specifically, the ECU 7 is configured to set the TCV 52 to a fully closed state where the opening area of the intake flow path 4a is minimized (the opening area does not become zero) such that the pressure between the TCV 52 and the intake valve 26a of the combustion chamber 23 increases during the pre-ignition motor drive period. Moreover, the TCV 52 continuously maintains an intake state of sensing intake air to the combustion chamber 23 even when the opening degree is changed. That is, the fully closed state of the TCV 52 is a state where the TCV 52 has a predetermined opening area, and in the fully closed state of the TCV 52, the intake state where the intake air is sent to the combustion chamber 23 is maintained.

That is, the ECU 7 is configured to close the TCV 52 such that the opening area through which the intake air passes is made smaller during the pre-ignition motor drive period than when ignition (firing) is performed. In this way, the ECU 7 may effectively increase the pressure between the TCV 52 and the intake valve 26a and in a cylinder 24 (the combustion chamber 23) during a compression stroke of the pre-ignition motor drive period. As a result, the ECU 7 may increase the wall surface temperature of the intake flow path 4a between the TCV 52 and the intake valve 26a, the wall surface temperature of the combustion chamber 23, and the temperature of water in the engine (i.e., the temperature of cooling water W in the engine body 2), for example.

Thus, the ECU 7 may effectively atomize the fuel between the TCV 52 and the intake valve 26a and in the cylinder 24 (the combustion chamber 23) and may effectively reduce exhaust gas (e.g., HC, NOx, or CO) after first ignition (first explosion).

The engine body 2 includes a cylinder block 21 and a cylinder head 22 mounted on the top of the cylinder block 21. The cylinder block 21 has the cylinder 24 in which the combustion chamber 23 is defined. A piston 24a is disposed in the cylinder 24. A crankshaft (not illustrated) is provided in the engine body 2. In addition, the engine body 2 is provided with the intake valve 26a and an exhaust valve 26b. The engine 100 opens and closes each of the intake valve 26a and the exhaust valve 26b with a predetermined valve timing by rotating camshafts 25a and 25b using the power of the crankshaft.

The cylinder block 21 is provided with a water jacket 27 for circulating the cooling water W which cools the engine 100. The water jacket 27 is disposed adjacent to the combustion chamber 23. At the time of motoring, the temperature of the engine 100 (the combustion chamber 23 and the cylinder 24) increases due to friction between the piston 24a and the cylinder 24 or the compression of air in the cylinder 24 (in the combustion chamber 23). Therefore, at the time of motoring, the temperature of the cooling water W also increases by removing heat from the engine 100 having the increased temperature. The water jacket 27 is provided with a temperature sensor 27a capable of measuring the temperature (engine water temperature) of the cooling water W in the engine body 2. The measured value of the temperature sensor 27a is acquired by the ECU 7.

The variable valve mechanism 3 is configured to be able to adjust the opening and closing timing of the intake valve 26a and the exhaust valve 26b of the combustion chamber 23. Specifically, the variable valve mechanism 3 is configured to retard the rotation of the camshafts 25a and 25b independently of each other in a retardation angle direction or an advance angle direction in order to retard the opening and closing timing of the intake valve 26a and the exhaust valve 26b.

That is, the variable valve mechanism 3 is configured to advance or retard both the opening timing (hereinafter referred to as intake valve open (IVO)) and the closing timing (hereinafter referred to as intake valve close (IVC)) of the intake valve 26a.

Further, the variable valve mechanism 3 is configured to advance or retard both the opening timing (hereinafter referred to as exhaust valve open (EVO)) and the closing timing (hereinafter referred to as exhaust valve close (EVC)) of the exhaust valve 26b. Furthermore, the variable valve mechanism 3 is configured to be driven under the control of the ECU 7.

The intake flow path 4a is configured to supply intake air to the combustion chamber 23 through the intake valve 26a. The exhaust flow path 4b is configured to discharge air (exhaust gas) discharged from the combustion chamber 23 through the exhaust valve 26b to the outside (atmosphere). A catalyst C and a muffler F are provided in the exhaust flow path 4b. The intake flow path 4a and the exhaust flow path 4b are provided with an exhaust gas recirculation (EGR) mechanism (not illustrated) for recirculating EGR gas.

The fuel injection device 51 is provided in the intake flow path 4a. The fuel injection device 51 is configured to inject the fuel into the intake flow path 4a just in front of the intake valve 26a. The TCV 52 is provided on the upstream side of the fuel injection device 51 provided in the intake flow path 4 and on the downstream side of a throttle valve (not illustrated). Further, the TCV 52 is configured such that the opening degree thereof is adjusted while maintaining the intake state through the intake flow path 4a. In addition, the fuel injection device 51 and the TCV 52 are configured to be driven under the control of the ECU 7.

The electric motor 6 is configured to drive the piston 24a at the time of starting and at the time of a normal operation. The electric motor 6 is configured to drive the engine 100 at the time of motoring at a predetermined rotation speed smaller than the rotation speed after ignition (see FIG. 5). In addition, the electric motor 6 is configured to be driven under the control of the ECU 7.

### <Configuration of ECU>

The ECU 7 is configured to control each part of the engine 100. As described above, the ECU 7 is configured to control the electric motor 6 and the variable valve mechanism 3 such that the engine body 2 is effectively warmed up at the time of motoring. Thus, the ECU 7 is configured to effectively boost the pressure between the TCV 52 and the intake valve 26a and in the cylinder 24 (in the combustion chamber 23) so as to promote atomization of the fuel at the time of first explosion (when the fuel is supplied to the combustion chamber 23 and is first ignited) (at the time of starting) and reduce the exhaust gas immediately after the first explosion.

That is, as illustrated in FIG. 5, at the time of cold starting, the ECU 7 is configured to set the TCV 52 to a closing direction side such that the pressure between the TCV 52 and the intake valve 26a of the combustion chamber 23 increases during the pre-ignition motor drive period. Specifically, the ECU 7 is configured to set the TCV 52 to a fully closed state where the opening area of the intake flow path 4a is minimized during the pre-ignition motor drive period.

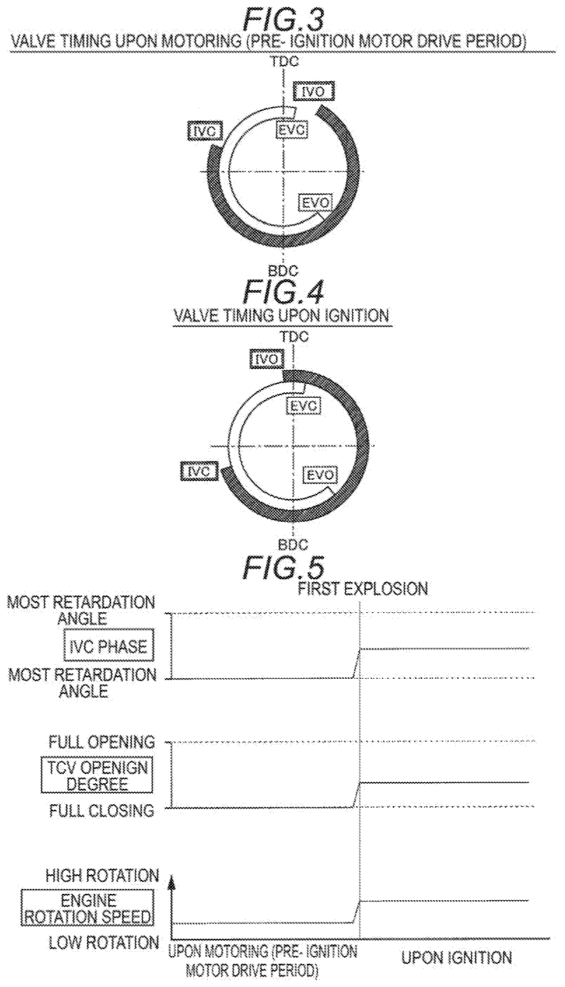

Further, as illustrated in FIGS. 3 and 5, the ECU 7 is configured to set the opening and closing timing of the intake valve 26a by the variable valve mechanism 3 to be closer to a retardation angle side (the most retardation angle) than that of the time of a steady operation after ignition in the combustion chamber 23 during the pre-ignition motor drive period, and to set the TCV 52 to the closing direction side such that the pressure between the TCV 52 and the intake valve 26a of the combustion chamber 23 increases. The IVC, which is the most retardation angle at this time, is set, for example, to a phase of IVC from about 90 degrees or more to 120 degrees or less (see FIG. 3). In this manner, the ECU 7 may cause high-pressure and high-temperature air to be effectively blown back from the combustion chamber 23 to the intake flow path 4a in the compression stroke. The blown-back high-pressure and high-temperature air is prevented from flowing backward by the TCV 52 and is confined between the TCV 52 and the intake valve 26a to increase the wall surface temperature of the intake flow path 4a between the TCV 52 and the intake valve 26a and the temperature of the fuel injection device 51.

Further, the ECU 7 is configured to end, at a predetermined timing, control to set the TCV 52 to a fully closed state where the opening area of the intake flow path 4a is minimized and control to set the opening and closing timing of the intake valve 26a to be closer to a retardation angle side than that of the time of a steady operation after ignition in the combustion chamber 23, in order to perform first ignition.

Specifically, the ECU 7 is configured to complete (end) control to set the TCV 52 to the closing direction side such that the pressure between the TCV 52 and the intake valve 26a of the combustion chamber 23 increases, and perform first ignition in the combustion chamber 23 based on the condition that the engine water temperature (the temperature of the cooling water W in the engine body 2) has reached a predetermined temperature. Further, the ECU 7 is configured to complete control to set the timing at which the intake valve 26a is closed to be closer to a retardation angle side (the most retardation angle) than that of the time of a steady operation after ignition in the combustion chamber 23, and perform first ignition in the combustion chamber 23 based on the condition that the engine water temperature has reached a predetermined temperature. Further, the ECU 7 is configured to complete driving of the piston 24a by the electric motor 6 based on the condition that the engine water temperature has reached a predetermined temperature in the pre-ignition motor drive period.

In addition, the predetermined temperature is a temperature at which atomization of the fuel is appropriately performed in the combustion chamber 23, and is the engine water temperature when the air temperature in the combustion chamber 23 becomes, for example, about 30° C. or more (about 40° C. or more). The ECU 7 acquires the engine water temperature (a predetermined temperature of the cooling water) from the temperature sensor 27a.

Further, the ECU 7 is configured to set (change) the opening degree of each of the TCV 52 and the intake valve 26a to a predetermined opening degree for ignition before performing first ignition in the combustion chamber 23 based on the condition that the engine water temperature has reached a predetermined temperature.

Specifically, as illustrated in FIGS. 4 and 5, the ECU 7 is configured to set the IVC (see FIG. 3) to a more advance angle side than during the pre-ignition motor drive period based on the condition that the engine water temperature has reached a predetermined temperature. For example, the ECU 7 sets the IVC to a substantially intermediate angle between the most advance angle and the most retardation angle. Further, the ECU 7 is configured to set the TCV 52 to a more opening direction side than during the pre-ignition motor drive period based on the condition that the engine water temperature has reached a predetermined temperature. That is, the ECU 7 is configured to drive the TCV 52 to increase the opening area of the intake flow path 4a.

### <Starting Control Processing of Engine by ECU>

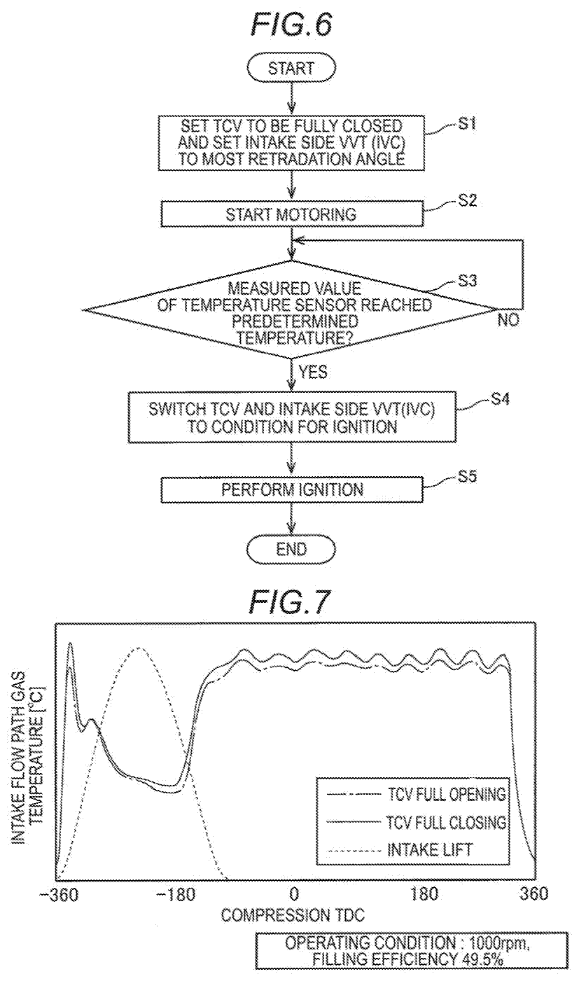

Next, a starting control processing of the engine 100 until first ignition is performed by the ECU 7 will be described with reference to FIG. 6.

First, in step 51, the ECU 7 sets the TCV 52 and the IVC of the intake valve 26a by the variable valve mechanism 3 to a condition for motoring until ignition. That is, the ECU 7 sets the TCV 52 to the closing direction side (a fully closed state) such that the pressure between the TCV 52 and the intake valve 26a of the combustion chamber 23 increases, and sets the timing at which the intake valve 26a is opened to be closer to a retardation angle side (the most retardation angle) than that of the time of a steady operation after ignition.

Next, in step S2, the ECU 7 starts motoring. That is, the driving of the crankshaft via the electric motor 6 is started by the ECU 7. At this time, since the setting of the TCV 52 and the variable valve mechanism 3 executed in step S1 may cause the air to be effectively blown back to the intake flow path 4a in the compression stroke, the pressure between the combustion chamber 23 and the intake valve 26a and in the cylinder 24 (in the combustion chamber 23) is effectively boosted.

Next, in step S3, the ECU 7 determines whether the measured value of the temperature sensor 27a has reached a predetermined temperature (the temperature at which the fuel is appropriately atomized). When it is determined that the measured value has not reached the predetermined temperature, step S3 is repeated. When the measured value has reached the predetermined temperature, the processing proceeds to step S4.

Next, in step S4, the ECU 7 changes the TCV 52 and the IVC of the intake valve 26a by the variable valve mechanism 3 to a condition for ignition. Specifically, the IVC is set to a more advance angle side than the IVC (the most retardation angle) during the pre-ignition motor drive period, and the TCV 52 is set to the opening direction side than in the fully closed state. That is, in order to appropriately perform ignition, control is performed to reduce the amount of intake air to be blown back and to increase the amount of intake air to be supplied to the combustion chamber 23.

Next, in step S5, the ECU 7 performs first ignition. In this way, the starting control of the engine 100 until first ignition is performed by the ECU 7 is completed.

### (Comparison Between Fully Closed State and Fully Opened State of TCV)

Next, comparison of two cases of the fully closed state and the fully opened state of the TCV 52 will be described with reference to FIG. 7. As operating conditions, the engine rotation speed was 1000 rpm and the filling efficiency was 49.5%. In this case, the gas temperature in the intake flow path 4a corresponding to the angle of the crankshaft in a case where one cycle of motoring (warming up) was performed was measured. As a result, when the TCV 52 was fully closed, the temperature was generally higher than when the TCV 52 was fully opened (a difference of about 6° C. was made on average).

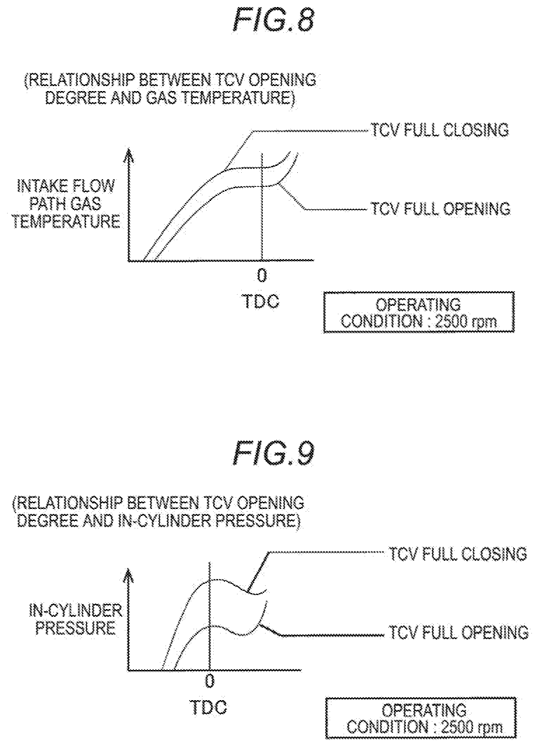

Further, referring to FIGS. 8 and 9, the gas temperature in the intake flow path 4a and the in-cylinder pressure were measured in the vicinity of the TDC under operating conditions different from the above operating conditions. As the operating condition, the engine speed was 2500 rpm. As a result, when the TCV 52 was fully closed, the temperature is increased by about 5° C. and the pressure is increased in the vicinity of the TDC compared to when the TCV 52 was fully opened.

### Effects of Present Embodiment

In the present embodiment, the following effects may be obtained.

In the present embodiment, as described above, the ECU 7 sets the TCV 52 to the closing direction side such that the pressure between the TCV 52 and the intake valve 26a of the combustion chamber 23 increases during the pre-ignition motor drive period until the fuel is supplied to the combustion chamber 23 and is first ignited. Thus, since the temperature around the fuel injection device 51 (e.g., the wall surface temperature of the intake flow path 4a) may be increased by increasing the pressure between the TCV 52 and the intake valve 26a, the fuel injected from the fuel injection device 51 may be effectively atomized. As a result, the amount of exhaust gas generated immediately after first ignition (at the time of starting) may be effectively reduced. In addition, the reason why the pressure between the TCV 52 and the intake valve 26a of the combustion chamber 23 increases is because the TCV 52 prevents the backflow of air blown back from the combustion chamber 23 to the intake flow path 4a, so that a large amount of air may be confined between the TCV 52 and the intake valve 26a (the combustion chamber 23). At this time, the pressure in the combustion chamber 23 may also be boosted to increase the temperature in the combustion chamber.

In the present embodiment, as described above, at the time of cold starting, the ECU 7 is configured to set the TCV 52 to the closing direction side such that the pressure between the TCV 52 and the intake valve 26a of the combustion chamber 23 increases during the pre-ignition motor drive period. This makes it possible to reliably reduce the amount of exhaust gas generated at the time of starting, even at the time of cold starting where exhaust gas is particularly easily generated.

In the present embodiment, as described above, the engine further includes the variable valve mechanism 3 capable of adjusting the opening and closing timing of the intake valve 26a of the combustion chamber 23 under the control of the ECU 7, and the controller is configured to set the closing timing of the intake valve 26a to be closer to a retardation angle side than that of the time of a steady operation after ignition, and set the TCV 52 to the closing direction side such that the pressure between the TCV 52 and the intake valve 26a of the combustion chamber 23 increases during the pre-ignition motor drive period. Thus, since a period during which the piston 24a moves from the bottom dead center to the top dead center in a state where the intake valve 26a is opened (the compression stroke when the intake valve 26a is opened) may be made longer to increase a greater amount of air blown back to the intake flow path 4a, the pressure between the TCV 52 and the intake valve 26a of the combustion chamber 23 may be made higher. As a result, the amount of exhaust gas generated at the time of starting may be further effectively reduced.

In the present embodiment, as described above, the ECU 7 is configured to complete control to set the TCV 52 to the closing direction side such that the pressure between the TCV 52 and the intake valve 26a of the combustion chamber 23 increases, and perform first ignition in the combustion chamber 23 based on the condition that the temperature of the cooling water W in the engine body 2 has reached a predetermined temperature. Thus, since control to set the TCV 52 to the closing direction side such that the pressure between the TCV 52 and the intake valve 26a of the combustion chamber 23 increases may be completed at the optimum temperature at which atomization of the fuel is effectively performed, the amount of exhaust gas generated at the time of starting may be further effectively reduced.

In the present embodiment, as described above, the engine further includes the variable valve mechanism 3 capable of adjusting the opening and closing timing of the intake valve 26a of the combustion chamber 23 under the control of the ECU 7, and the controller is configured to set the opening degree of each of the TCV 52 and the intake valve 26a to a predetermined opening degree for ignition before performing first ignition in the combustion chamber 23 based on the condition that the temperature of the cooling water W in the engine body 2 has reached a predetermined temperature. Thus, since the opening area of the intake flow path 4a may be made larger than during the pre-ignition motor drive period by the TCV 52, and first ignition may be performed in a state where the backflow of air to the intake flow path 4a is prevented by the variable valve mechanism 3, the amount of exhaust gas generated at the time of starting may be further reduced.

### [Modifications]

It should be understood that the embodiment disclosed herein is illustrative and non-restrictive in every respect. The scope disclosed here is indicated not by the description of the above embodiment but by the claims, and further includes all modifications (variations) within the meaning and scope equivalent to the claims.

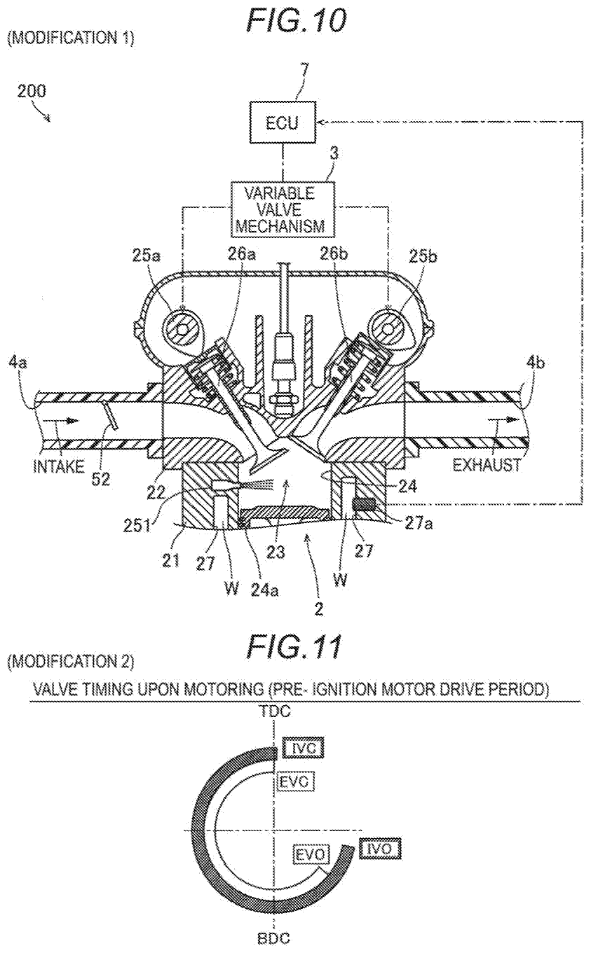

For example, the embodiment has illustrated an example in which the fuel injection device is formed in the intake flow path, but this disclosure is not limited thereto. In this disclosure, as in the engine 200 of a first modification illustrated in FIG. 10, a fuel injection device 251 may be provided in the cylinder 24 so as to directly inject fuel into the combustion chamber 23.

Further, the above embodiment has illustrated an example in which the IVC at the time of motoring is set to a more advance angle side than the top dead center (TDC), but this disclosure is not limited thereto. In this disclosure, as at the valve timing of a second modification illustrated in FIG. 11, the IVC at the time of motoring may be set to the vicinity of the top dead center (TDC) on the more retardation angle side. That is, the IVC may be set to an extremely late timing. Thus, since air may be blown back to the intake flow path substantially throughout the compression stroke, the pressure between the TCV and the intake valve may be further effectively increased.

Further, the above embodiment has illustrated an example in which, the controller is configured to complete control to set the TCV to the closing direction side such that the pressure between the TCV and the intake valve of the combustion chamber increases based on the condition that the temperature of the cooling water in the engine body has reached a predetermined temperature, but this disclosure is not limited thereto. In this disclosure, the controller may be configured to complete control to set the TCV to the closing direction side such that the pressure between the TCV and the intake valve of the combustion chamber increases based on the condition that, for example, the wall surface temperature of the combustion chamber or the wall surface temperature of the intake flow path has reached a predetermined temperature.

Further, the embodiment has illustrated an example which the controller is configured to perform control to blow air back to the intake flow path during a compression stroke, but this disclosure is not limited thereto. In this disclosure, the controller may be configured to perform control to blow air back to the intake flow path during an exhaust stroke.

Further, the above embodiment has illustrated an example in which the engine has an electric motor, but this disclosure is not limited thereto. In this disclosure, the engine may have a starter motor other than the electric motor.

Further, the above embodiment has illustrated an example in which the pressure between the TCV and the intake valve of the combustion chamber is increased by the TCV at the time of cold starting, but this disclosure is not limited thereto. In this disclosure, control to increase the pressure between the TCV and the intake valve of the combustion chamber may be performed by the TCV at the time of any other time than cold starting.

Further, the above embodiment has illustrated an example in which the intake control valve disclosed here is configured with the TCV, but this disclosure is not limited thereto. In this disclosure, the intake control valve may be configured with a valve other than the TCV such as a throttle valve.

Further, for convenience of explanation, the above embodiment has described a processing operation of the controller using a flow drive type flowchart in which a processing is sequentially performed along the processing flow, but this disclosure is not limited thereto. In this disclosure, the processing operation of the controller may be executed by an event drive type (event driven type) processing that executes a processing for each event. In this case, the operation may be completely executed in an event driven type, or may be executed in a combined manner of the event drive type and the flow drive type.

An internal combustion engine according to an aspect of this disclosure includes an intake control valve provided on an upstream side of a fuel injection device provided in an intake flow path and configured to adjust an opening degree thereof while maintaining an intake state through the intake flow path and a controller configured to perform control to adjust the opening degree of the intake control valve, in which the controller is configured to set the intake control valve to a closing direction side such that a pressure between the intake control valve and an intake valve of a combustion chamber increases during a pre-ignition motor drive period until a fuel is supplied to the combustion chamber and first ignited.

In the internal combustion engine according to the aspect of this disclosure, as described above, the controller sets the intake control valve to the closing direction side such that the pressure between the intake control valve and the intake valve of the combustion chamber increases during the pre-ignition motor drive period until the fuel is supplied to the combustion chamber and is first ignited. Thus, since the temperature around the fuel injection device (e.g., the wall surface temperature of the intake flow path) may be increased by increasing the pressure between the intake control valve and the intake valve, the fuel injected from the fuel injection device may be effectively atomized. As a result, the amount of exhaust gas generated immediately after first ignition (at the time of starting) may be effectively reduced. In addition, the reason why the pressure between the intake control valve and the intake valve of the combustion chamber increase is because the backflow of air blown back from the combustion chamber to the intake flow path is prevented by the intake control valve, so that a large amount of air is confined between the intake control valve and the intake valve (the combustion chamber). At this time, the inside of the combustion temperature may also be increased by boosting the pressure in the combustion chamber.

In the internal combustion engine according to the aspect, it is preferable that the controller is configured to set the intake control valve to the closing direction side such that the pressure between the intake control valve and the intake valve of the combustion chamber increases during the pre-ignition motor drive period at the time of cold starting.

According to the configuration described above, the amount of exhaust gas generated at the time of starting may be reliably reduced even at the time of cold starting in which the exhaust gas is particularly easily generated.

In the internal combustion engine according to the above aspect, it is preferable that the internal combustion engine further includes a variable valve mechanism configured to adjust an opening and closing timing of the intake valve of the combustion chamber under control of the controller, and the controller is configured to set a closing timing of the intake valve by the variable valve mechanism to be closer to a retardation angle side than that of the time of a steady operation after ignition during the pre-ignition motor drive period, and set the intake control valve to the closing direction side such that the pressure between the intake control valve and the intake valve of the combustion chamber increases.

According to the configuration described above, since a period during which a piston moves from the bottom dead center to the top dead center in a state where the intake valve is opened (a compression stroke in a state where the intake valve is opened) may be made longer, thus causing a greater amount of air to be blown back to the intake flow path, the pressure between the intake control valve and the intake valve of the combustion chamber may be further increased. As a result, the amount of exhaust gas generated at the time of starting may be further effectively reduced.

In the internal combustion engine according to the above aspect, it is preferable that the controller is configured to complete control to set the intake control valve to the closing direction side such that the pressure between the intake control valve and the intake valve of the combustion chamber increases, and perform first ignition in the combustion chamber based on a condition that a wall surface temperature of the combustion chamber, a temperature of cooling water in an internal combustion engine body, or a wall surface temperature of the intake flow path has reached a predetermined temperature.

According to the configuration described above, since control to set the intake control valve to the closing direction side such that the pressure between the intake control valve and the intake valve of the combustion chamber increases may be completed at the optimum temperature at which atomization of the fuel may be effectively performed, the amount of exhaust gas generated at the time of starting may be further effectively reduced.

In this case, it is preferable that the internal combustion engine further includes a variable valve mechanism configured to adjust an opening and closing timing of the intake valve of the combustion chamber under control of the controller, and the controller is configured to set an opening degree of each of the intake control valve and the intake valve to a predetermined opening degree for ignition before performing first ignition in the combustion chamber based on a condition that a wall temperature of the combustion chamber, a temperature of cooling water in an internal combustion engine body, or a wall surface temperature of the intake flow path has reached a predetermined temperature.

According to the configuration described above, since the opening area of the intake flow path may be made larger by the intake control valve than during the pre-ignition motor drive period, and first ignition may be performed in a state where the backflow of air to the intake flow path is prevented by the variable valve mechanism, the amount of exhaust gas generated at the time of starting may be further reduced.

In the internal combustion engine in which the controller completes control of the intake control valve to increase the pressure between the intake control valve and the intake valve of the combustion chamber based on the condition that the wall surface temperature of the combustion chamber, the temperature of the cooling water in the internal combustion engine body, or the wall surface temperature of the intake flow path has reached a predetermined temperature, it is preferable that the internal combustion engine further includes a hybrid drive motor configured to drive a piston at the time of starting and at the time of a normal operation, and the controller is configured to complete driving of the piston by the hybrid drive motor based on the condition that the wall temperature of the combustion chamber, the temperature of the cooling water in the internal combustion engine body, or the wall surface temperature of the intake flow path has reached a predetermined temperature during the pre-ignition motor drive period.

According to the configuration described above, in a hybrid vehicle in which the internal combustion engine does not need to drive wheels at the time of starting, control of the intake control valve may be performed to increase the pressure between the intake control valve and the intake valve of the combustion chamber during a relatively long time to start the internal combustion engine. As a result, the amount of exhaust gas generated at the time of starting may be further effectively reduced.

Further, in the internal combustion engine in which the controller completes control of the intake control valve to increase the pressure between the intake control valve and the intake valve of the combustion chamber based on the condition that the wall surface temperature of the combustion chamber, the temperature of the cooling water in the internal combustion engine body, or the wall surface temperature of the intake flow path has reached a predetermined temperature, it is preferable that the internal combustion engine further includes a starter motor configured to drive a piston at the time of starting, and the controller is configured to complete driving of the piston by the starter motor based on the condition that the wall temperature of the combustion chamber, the temperature of the cooling water in the internal combustion engine body, or the wall surface temperature of the intake flow path has reached a predetermined temperature during the pre-ignition motor drive period.

According to the configuration described above, even in a non-hybrid vehicle that is started by the starter motor, the amount of exhaust gas generated at the time of starting may be effectively reduced.

In the internal combustion engine according to the above aspect, it is preferable that the controller is configured to set the intake control valve to a fully closed state where an opening area of the intake flow path is minimized such that the pressure between the intake control valve and the intake valve of the combustion chamber increases during the pre-ignition motor drive period.

According to the configuration described above, since air blown back from the combustion chamber to the intake flow path may be more reliably prevented from flowing back to the upstream side of the intake control valve, the pressure between the intake control valve and the intake valve may be further effectively increased.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An internal combustion engine comprising:
an intake control valve provided on an upstream side of a fuel injection device provided in an intake flow path and configured to adjust an opening degree thereof while maintaining an intake state through the intake flow path; and
a controller configured to perform control to adjust the opening degree of the intake control valve, wherein
the controller is configured to set the intake control valve to a closing direction side such that a pressure between the intake control valve and an intake valve of a combustion chamber increases during a pre-ignition motor drive period until a fuel is supplied to the combustion chamber and first ignited.

2. The internal combustion engine according to claim 1, wherein
the controller is configured to set the intake control valve to the closing direction side such that the pressure between the intake control valve and the intake valve of the combustion chamber increases during the pre-ignition motor drive period at the time of cold starting.

3. The internal combustion engine according to claim 1, further comprising:
a variable valve mechanism configured to adjust an opening and closing timing of the intake valve of the combustion chamber under control of the controller, wherein
the controller is configured to set a closing timing of the intake valve by the variable valve mechanism to be closer to a retardation angle side than that of the time of a steady operation after ignition during the pre-ignition motor drive period, and set the intake control valve to the closing direction side such that the pressure between the intake control valve and the intake valve of the combustion chamber increases.

4. The internal combustion engine according to claim 1, wherein
the controller is configured to complete control to set the intake control valve to the closing direction side such that the pressure between the intake control valve and the intake valve of the combustion chamber increases, and perform first ignition in the combustion chamber based on a condition that a wall surface temperature of the combustion chamber, a temperature of cooling water in an internal combustion engine body, or a wall surface temperature of the intake flow path has reached a predetermined temperature.

5. The internal combustion engine according to claim 4, further comprising:
a variable valve mechanism configured to adjust an opening and closing timing of the intake valve of the combustion chamber under control of the controller, wherein
the controller is configured to set an opening degree of each of the intake control valve and the intake valve to a predetermined opening degree for ignition before performing first ignition in the combustion chamber based on a condition that a wall temperature of the combustion chamber, a temperature of cooling water in an internal combustion engine body, or a wall surface temperature of the intake flow path has reached a predetermined temperature.

6. The internal combustion engine according to claim 4, further comprising:
a hybrid drive motor configured to drive a piston at the time of starting and at the time of a normal operation, wherein
the controller is configured to complete driving of the piston by the hybrid drive motor based on the condition that the wall temperature of the combustion chamber, the temperature of the cooling water in the internal combustion engine body, or the wall surface temperature of the intake flow path has reached a predetermined temperature during the pre-ignition motor drive period.

7. The internal combustion engine according to claim 4, further comprising:
a starter motor configured to drive a piston at the time of starting, wherein
the controller is configured to complete driving of the piston by the starter motor based on the condition that the wall temperature of the combustion chamber, the temperature of the cooling water in the internal combustion engine body, or the wall surface temperature of the intake flow path has reached a predetermined temperature during the pre-ignition motor drive period.

8. The internal combustion engine according to claim 4, wherein
the controller is configured to set the intake control valve to a fully closed state where an opening area of the intake flow path is minimized such that the pressure between the intake control valve and the intake valve of the combustion chamber increases during the pre-ignition motor drive period.
